(19) United States
(12) Patent Application Publication
(10) Pub. No.: US 2021/0233008 A1
(43) Pub. Date: Jul. 29, 2021

(54) OILFIELD DATA FILE CLASSIFICATION AND INFORMATION PROCESSING SYSTEMS

(71) Applicant: Schlumberger Technology Corporation, Sugar Land, TX (US)

(72) Inventors: Supriya Gupta, Houston, TX (US); Jason Baihly, Katy, TX (US); Saniya Karnik, Houston, TX (US); David Rossi, Houston, TX (US); Andrew Acock, Houston, TX (US); Asim Malik, Houston, TX (US)

(21) Appl. No.: 16/890,208

(22) Filed: Jun. 2, 2020

Related U.S. Application Data
(60) Provisional application No. 62/966,753, filed on Jan. 28, 2020.

(51) Int. Cl. G06Q 10/06; G06F 16/28; G06Q 50/02; G06Q 10/04; G06N 20/00; G06F 30/20; E21B 47/00

(52) U.S. Cl. CPC G06Q 10/06375; G06F 16/287; G06Q 50/02; G06Q 10/04; G06Q 10/20; G06F 30/20; E21B 47/00; G06Q 10/067; G06N 20/00

(57) ABSTRACT

A method for analyzing data includes obtaining data objects from a data repository. The data objects include observational data related to one or more oil wells, oil fields, or a combination thereof. The method also includes classifying the data objects based on data contained therein using a machine-learning algorithm, and determining output data from the data objects after classifying the data objects. The output data represents one or more historical data analytics for the one or more oil wells, oil fields, or a combination thereof. The method further includes visualizing the output data including the one or more historical data analytics.

### CROSS-REFERENCE TO RELATED APPLICATIONS

This application claims priority to U.S. Provisional Patent Application having Ser. No. 62/966,753, which was filed on Jan. 28, 2020, and is incorporated herein by reference in its entirety.

### BACKGROUND

In the oil and gas industry, service providers and owners may have vast volumes of unstructured data and use less than 1% of it to uncover meaningful insights about field operations. Moreover, even at such low utilization rates, most of an oilfield expert's time can be spent manually organizing oilfield data. When processing decades of historical oilfield data spread across both structured (production time series) and unstructured records (workover reports), experts often face challenges including rapidly organizing and analyzing thousands of historical records, leveraging the historical information to make more informed operating expense decisions, and identifying economically successful workovers (candidates and types).

### SUMMARY

Embodiments of the disclosure provide a method for analyzing data that includes obtaining data objects from a data repository. The data objects include observational data related to one or more oil wells, oil fields, or a combination thereof. The method also includes classifying the data objects based on data contained therein using a machine-learning algorithm, and determining output data from the data objects after classifying the data objects. The output data represents one or more historical data analytics for the one or more oil wells, oil fields, or a combination thereof. The method further includes visualizing the output data including the one or more historical data analytics.

Embodiments of the disclosure also provide a computing system that includes one or more processors, and a memory system including one or more non-transitory, computer-readable media storing instructions that, when executed by at least one of the one or more processors cause the computing system to perform operations. The operations include obtaining data objects from a data repository. The data objects include observational data related to one or more oil wells, oil fields, or a combination thereof. The operations also include classifying the data objects based on data contained therein using a machine-learning algorithm, and determining output data from the data objects after classifying the data objects. The output data represents one or more historical data analytics for the one or more oil wells, oil fields, or a combination thereof. The operations further include visualizing the output data including the one or more historical data analytics.

Embodiments of the disclosure further provide a non-transitory, computer-readable medium storing instructions that, when executed by at least one processor of a computing system, cause the computing system to perform operations. The operations include obtaining data objects from a data repository. The data objects include observational data related to one or more oil wells, oil fields, or a combination thereof. The operations also include classifying the data objects based on data contained therein using a machine-learning algorithm, and determining output data from the data objects after classifying the data objects. The output data represents one or more historical data analytics for the one or more oil wells, oil fields, or a combination thereof. The operations further include visualizing the output data including the one or more historical data analytics.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a block diagram of a method for data organization and oilfield insight generation, according to an embodiment.

FIG. 3 illustrates a block diagram of a module for data organization and extraction, according to an embodiment.

FIG. 4 illustrates a block diagram of a data enrichment phase of the method, executed using a data enrichment module, according to an embodiment.

FIG. 5 illustrates oil production with episodic well intervention and time series model and forecast of each production segment, according to an embodiment.

FIG. 6 illustrates a diagram of workover intervention categories and percent production uplift from various well events, according to an embodiment.

FIG. 7 illustrate a plot of producing well counts in a field versus time, according to an example.

FIG. 8 illustrates a plot of production amount (e.g., in barrels) and daily cost as a function of time, according to an embodiment.

FIG. 9 illustrates a flowchart of a method for ingesting large amounts of oilfield data of various different types and using the ingested data for oilfield management and evaluation, among other things, according to an embodiment.

FIG. 10 illustrates a block diagram of input file organization and clustering, according to an embodiment.

FIGS. 11A and 11B illustrate dashboards for parameter tuning and feature selection, according to an embodiment.

FIG. 12 illustrates a flowchart of a method for unsupervised clustering of data files, e.g., documents pertaining to oilfield data, according to an embodiment.

FIG. 13 illustrates a two-dimensional representation of an output of a feature clustering process, according to an embodiment.

FIG. 14 illustrates a word cloud for a cluster in the output of FIG. 15, according to an embodiment.

FIG. 15 illustrates a schematic view of a computing system, according to an embodiment.

### DETAILED DESCRIPTION

In general, embodiments of the present disclosure provide a system and method for accessing, organizing, categorizing, and using a diverse set of historical data, generally for providing insight into oilfield operations. In some embodiments, the methods may be configured to access a variety of different types of observational data that may have been recorded potentially over decades. Some of the data may be handwritten or typed, freeform notes and logs, while other data may be in the form of structured spreadsheets and forms. Embodiments of the present disclosure may facilitate using such disparate data sources, not only by facilitating ingestion of these data files, but also by employing machine learning techniques to classify the documents, so they may be partitioned into helpful data sets. In one embodiment, the machine learning technique may involve an expert user tagging a training subset of the data files, which the machine learning technique may then employ as training data to begin labeling the remainder of the data files autonomously. In other embodiments, the machine learning technique may implement a clustering algorithm to recognize similar data files and documents, and create metadata related to identified clusters. A user may then identify the type of data contained within each of the clusters as a whole, e.g., using the metadata and/or other information. In either example case, the data in the classified/categorized documents may then be used to glean insights into, e.g., expected returns on various different types of oilfield activities, as will be discussed below.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### Oilfield Exploration and Management Environment

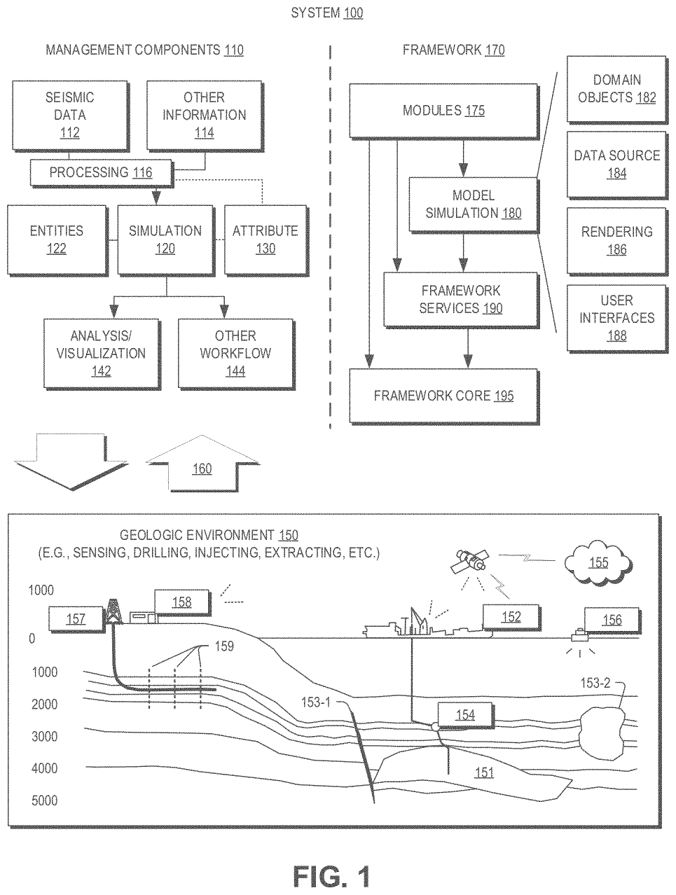

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., operations with respect to the geologic environment 150. In turn, further information about the geologic environment 150 may become available as feedback 160 (e.g., as input to one or more of the management components 110).

In the example of FIG. 1, the management components 110 include a seismic data component 112, an additional information component 114 (e.g., well/logging data, observational data, etc.), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In an embodiment, the simulation component 120 may simulate health and life of tools for tool efficiency and maintenance purposes. In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for collecting and/or using any type of oilfield data, which may include seismic data, borehole tool data (e.g., wireline, drilling, or fracturing), and surface equipment data (e.g., drilling rig data or artificial lift pump data), etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Data Processing and Oilfield Insight System

Natural language processing (NLP) and machine learning may enable ingestion and insight generation using field history data collected over the course of decades. Field history data can include any type of observational data related to any aspect of an oilfield, from exploration, to drilling, completion, treatment, intervention, production, and eventually shut-in. Such data may be in the form of well designs, well plans, drilling logs, geological data, wireline or other types of well logs, workover reports, production data, offset well data, etc. The present disclosure includes techniques that leverage artificial intelligence to process related operational information (e.g., the field history data mentioned above), both digital and handwritten, and the like. In some examples, the techniques herein can include extracting relevant information from documents, identifying patterns in production activity and associated operational events, training machine learning techniques to quantify the event's impact on production, and deriving practices for field operations.

In some examples, techniques herein include natural language processing libraries that can ingest and catalog large quantities of field data. The techniques herein can also identify sources of data related to extracting resources from a geological reservoir. For example, the techniques can identify a source of data that includes workover information and extract workover and cost information from the data sources. In some embodiments, a machine learning technique can be trained to predict well intervention categories and other categories for extracting resources from geological reservoirs. The machine learning technique can be trained based on text describing workovers (or other types of oilfield activities), among other information, identified in structured data sources and unstructured data sources. In some examples, the machine learning technique can be trained to identify a pattern and context of repeating words pertaining to a workover type (e.g., artificial lift, well integrity, etc.) and classify unstructured documents and structured documents accordingly. In some embodiments, statistical models can be generated to determine a return on investment from workovers and rank the workovers based on a production improvement and a payout time.

Embodiments of the present disclosure may employ autonomous systems or semi-autonomous systems, e.g., artificial intelligence or “AI”. Domain-led autonomous management of oil and gas fields may involve interactions among multiple agents and systems that use AI to collect data across complex information sources and generate insights from historical data in order to enhance production operations, operating expense reduction, and turnaround time for workover planning and field optimization. Building and training these autonomous machines generally includes application of methods of searching data and extracting information easily and intuitively.

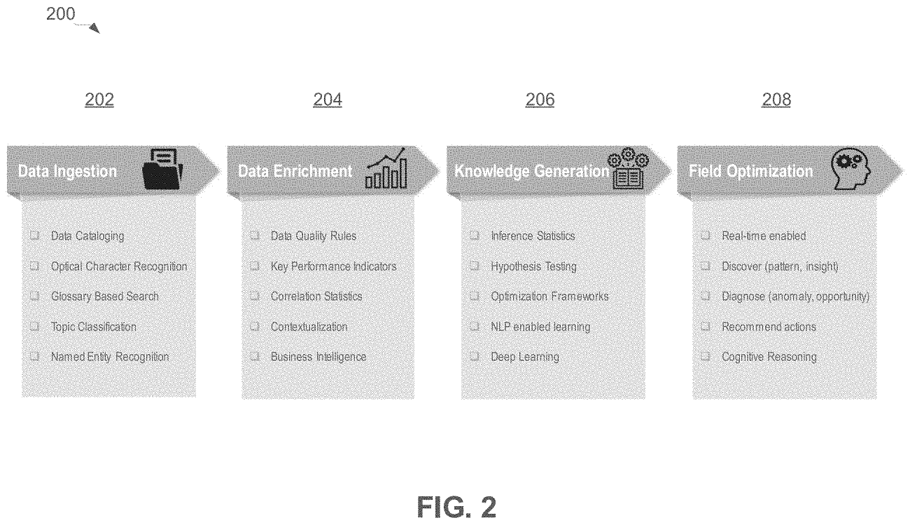

FIG. 2 illustrates a block diagram of a method 200 for data organization and oilfield insight generation, according to an embodiment. As an example, the method 200 may have four conceptual phases (which may be executable as software modules), namely: data ingestion 202, data enrichment 204, knowledge generation 206, and field optimization 208. It will be appreciated that additional phases may be provided, and/or any of the phases discussed herein may be combined or broken apart; indeed, the phases presented herein are for purposes of understanding the overall method and are not to be considered limiting.

In the data ingestion phase 202, oilfield data may be made available in an archive or another database or data repository available in a file server. The archive may have a complex folder hierarchy and contain thousands of files and gigabytes (or more) of data. The data may include both structured data (time series and relational databases) and unstructured data (documents and text-based files). The unstructured data may include both electronic documents and scanned copies of typed or handwritten documents. In some embodiments, the data ingestion 202 phase can include cataloging data, recognizing optical characters within the data, performing a glossary-based search, classifying topics, and recognizing named entities, among others.

As one example, a project in the oilfield production domain may begin with a “data room” exercise. During this phase, production experts may analyze thousands of digital and paper copies of field logs, records, and reports. The exercise may include receiving, organizing, and processing information related to a field's production potential to support a go/no-go decision to undertake a certain activity for the project. Such activities for which a go/no-go decision may be made include drilling operations, treatment operations, intervention operations, workover operations, artificial lift selections, production, well designs, etc., e.g., generally anything for which the likelihood of a financial return may be evaluated, e.g., in terms of cost versus production. The time frame for the data room exercise is usually constrained, since more than 80% of the experts' time may be spent gathering and organizing data. Therefore, automated techniques herein can enhance the accuracy and efficiency of properly interpreting the data, making meaningful associations, identifying pay zones, assessing future reserves, and analyzing the impact of historical operating patterns and capital spending.

Referring to the individual aspects of the data ingestion phase 202 in greater detail, the data ingestion phase 202 may include cataloging the data. As noted above, the data being catalogued is not assumed to be structured or unstructured, although it could be one or the other, the present method accounts for the possibility of the data being a mix of both. Accordingly, in some examples, the data ingestion phase 202 can include identifying unstructured data and applying optical character recognition where appropriate, e.g., to handwritten or other non-digital formats.

The data ingestion phase 202 can also include a glossary-based or “keyword” search functionality. In some embodiments, a glossary-based search can detect keywords from user input and search for the keywords in the structured data, the unstructured data, or a combination thereof. For example, the glossary-based search can detect and identify any suitable oil and gas term within a data repository. More particularly, glossary-based search terms can include search terms configured to identify a particular type of data, e.g., workover, rig, rod, pump, safety, incident, etc., may be terms that are useful in identifying workover reports.

In some examples, the data ingestion phase 202 may include topic classification, e.g., using the glossary-based search. Topic classification may include identifying or predicting a classification for a document based on the free-text and/or other content thereof, e.g., using one or more words representing a topic of an electronic document from a data repository. The topic classification may proceed based on an expert user identifying specific words associated with specific classes of documents. The user may search documents, based on certain keywords, and tag the documents with a particular classification.

In some embodiments, topic classification and/or another aspect of the data ingestion phase 202 may include named entity recognition. Named entity recognition may include identifying one or more words representing an entity, a project, or the like, within any number of documents of a data repository. The entity, project, etc., recognized by name may be added to metadata and/or otherwise employed to assist in classifying the data file.

Further, topic classification may employ metadata. Metadata is information about a data object, such as the identity of the creator (e.g., whether it was a drilling operator or a workover operator that prepared the document), the time at which the object was created, the type of file, etc. This information may be stored in association with the individual data objects, and may be employed to classify the topic of the data object.

As noted above, the next phase after the data ingestion phase 202 may be the data enrichment phase 204. In some embodiments, the data enrichment phase 204 may include determining data quality rules, key performance indicators, correlation statistics, contextualization techniques, and business intelligence techniques, among others. In some embodiments, the data quality rules can indicate a threshold resolution level for detecting handwriting with optical character recognition techniques. In some embodiments, the data quality rules can be used for removing outliers from time series data, handling missing data, removing stop words, and using stem words in unstructured data. Key performance indicators and correlation can provide production trends over time, workover costs over time, and the impact of workovers on production over short and long terms. Contextualization techniques may include understanding similarity of documents and assembling/grouping them. For example, contextualization may include searching for keyworks, e.g., common oil and gas terms, in documents and tagging the documents accordingly. Further business intelligence may include analyzing production metrics over time, e.g., through visualization plots

After the data enrichment phase 204, the method 200 may proceed to the knowledge generation phase 206. The knowledge generation phase 206 can include determining inference statistics, hypothesis testing, optimization frameworks, natural language processing enabled learning, and deep learning, among others. In some examples, machine driven intelligence may enhance the speed and efficiency of ingesting, organizing, and interpreting such large datasets. Natural language processing may facilitate automatically understanding years of field history and heterogeneous production records, including extracting the relevant oilfield data from free-text fields and translating data into a standardized data ecosystem which helps organize data into a machine readable and consumable format.

Embodiments of the present disclosure may employ an AI engine to generate actionable insights by increasing data utilization from unstructured data. The AI engine may aggregate and process decades of historical production data, including both structured data (production rates vs. time) and unstructured records (e.g., workover reports, drilling logs, production reports, etc.) across thousands of producing wells in multiple fields residing in gigabytes of data spread across complex folder hierarchy structure with diverse files and formats.

In some embodiments, the machine learning technique can be a neural network, a classification technique, a regression-based technique, a support-vector machine, and the like. In some examples, the neural network can include any suitable number of interconnected layers of neurons in various layers. For example, the neural network can include any number of fully connected layers of neurons that organize the field data provided as input. The organized data can enable visualizing a probability of a document belonging to a predetermined topic, or the like.

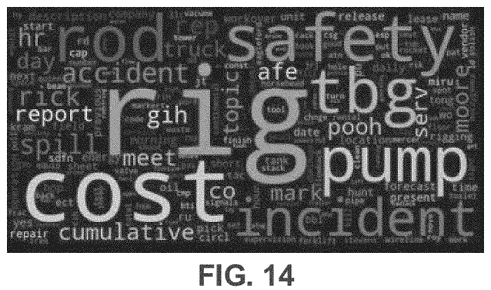

For example, the knowledge generation phase 206 can include generating a neural network that detects any number of input data streams, such as a structured data stream and an unstructured data stream, among others. In some embodiments, the neural network can detect fewer or additional data streams indicating classifications of terms such as “artificial lift” “electronic submersible pumps”, “rod pumps” or the like for workovers, or “drillstring”, “drilling rig”, or the like for drilling activities. In some examples, the neural network can include any suitable number of interconnected layers of neurons in various layers. For example, the neural network can include any number of fully connected layers of neurons that organize the data provided as input. The organized data can enable visualizing concepts identified within the data in a word map, which is described in greater detail below in relation to FIG. 14

Thus, machine intelligence workflows may be part of embodiments of the present disclosure. Such machine intelligence may enhance speed and efficiency of ingesting and interpreting large datasets for gaining insights into workover and operating expense. Embodiments of the present disclosure have the potential to drive automated field management. Indeed, embodiments may improve workover planning and operating expense spending by enabling rapid access to relevant content from historical records in an organized manner and learning patterns to better understand past strategies, capital spending, and make recommendations for improving production performance using an integrated workover plus operating expense digital workflow.

Embodiments of the present disclosure may thus provide an intelligent workflow that ingests data files at the well and field-level, in structured and unstructured formats, and provides tools and capabilities to organize and contextualize historical data related to workover interventions, model workover upside based on production and economic potential, identify bottlenecks and learn best practices from historical workover operations using natural language processing and machine learning techniques.

In some embodiments, the output from machine learning techniques can be used in field optimization 208 to recommend actions, diagnose anomalies, and discover patterns in real-time. Field optimization may include understanding the impact of historical field interventions to predict production and economic performance of future workovers, which may assist in selecting a beneficial and economical workover type and timeline for wells. Further, selection of a completion scheme and artificial lift techniques, and adoption of best practices associated therewith, may be facilitated using such output.

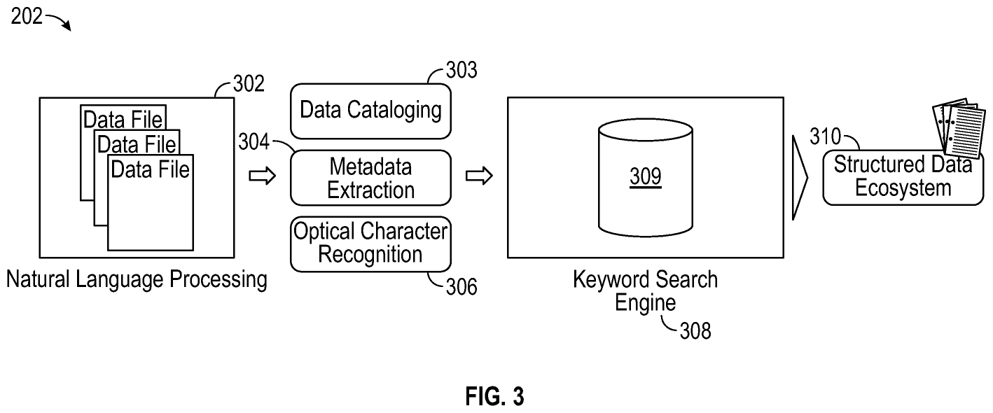

FIG. 3 illustrates a block diagram of an example of the data ingestion phase 202. The data ingestion phase 202 can include assimilating and organizing large volumes of structured and unstructured data, such as oilfield data, regardless of the shape, structure, or complexity of the data into a data repository. The data ingestion phase 202 can use natural language processing libraries in any suitable programming language, such as Python, among others, to perform the data processing of the “raw” or unsorted data objects in block 302. In some embodiments, the data ingestion phase can implement data cataloging 303 that includes organizing and arranging information by different file types and by user defined folder names. The data ingestion phase 302 can also implement metadata extraction 304 that includes separating a complex file folder hierarchy into a flat file structure and extracting metadata for each file or any other data. The metadata can include a file path, file type, or file size, among other information.

In some embodiments, the data ingestion phase 202 can be configured to extract and recognize various different formats of documents (e.g., PDF, excel, word, jpeg, txt, ppt, etc.). For complex handwritten, hand-typed, and scanned documents, optical character recognition 306 may be included. In some examples, the optical character recognition 306 can include detecting any number of handwritten alphanumerical characters and converting each of the handwritten alphanumerical characters into a predetermined digital alphanumerical format.

In order to make information across files searchable, a search engine 308 is implemented to search a database or another type of repository 309 of the ingested data objects (e.g., after cataloging, metadata extraction, and OCR). In some examples, the search engine 308 can search across different file types and find relevant files based on search criteria specified by the user. The search engine 308 can also return the files based on the order of importance and relevance of the search criteria. In some embodiments, the search engine 308 can read the data content of a file, such as a PDF file, among others, and assist in extracting files which are of importance to a user. For example, if the user wants to find workover reports from a data dump, the user can provide user input such as “workover” and the search engine 308 can output the files containing the word “workover” in descending order of the number of times the keyword occurs. The search engine 308 reduces user effort to identify requested information. Instead of trying to manually identify related files through gigabytes or petabytes of data, the search engine 308 can provide an automated technique for accessing and retrieving requested information. In some embodiments, the results of the search engine 308, such as keywords, resulting files, files ranked by importance, and file metadata, can be stored in a structured data ecosystem 310. In some embodiments, a user can classify documents returned by the keyword searching. This can be employed to train a machine-learning algorithm to classify other documents, as will be described in greater detail below.

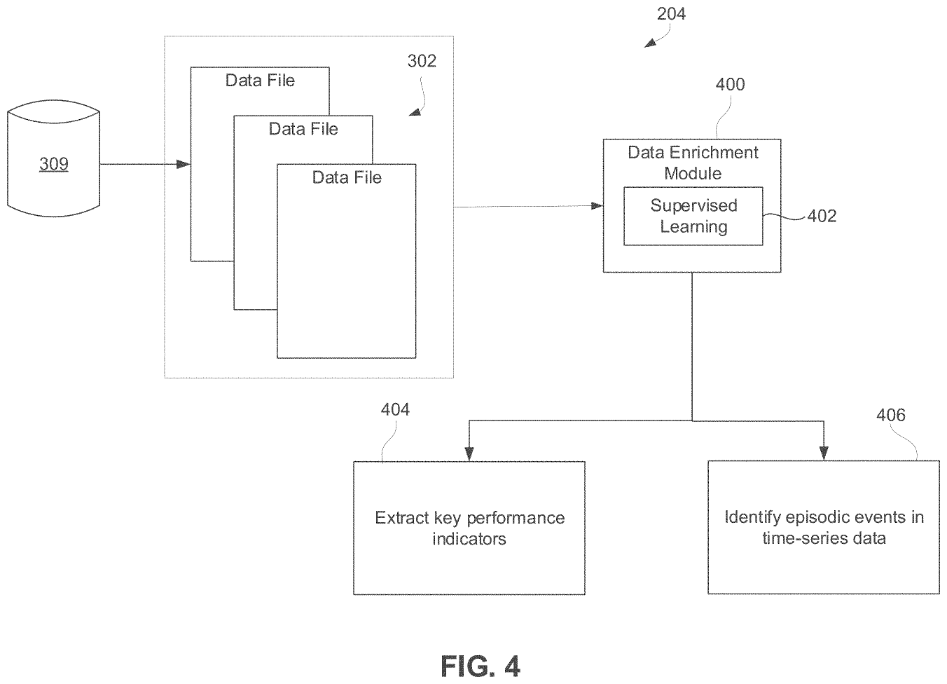

FIG. 4 illustrates a conceptual view of the data enrichment phase 204, executed at least partially using a data enrichment module 400. The data enrichment module 400 may be fed a subset of the data files 302 contained in the data repository 309. The subset of the data files 302 may be identified using a search engine, for example, as explained above, which may be part of the data ingestion module 202. The data enrichment module 400 may be configured to extract data based on context, perform fact extraction, obtain correlation statistics and calculate key performance indicators. The module 400 may classify and correlate information for multiple files by extracting data and facilitating associations of unstructured data (the reports) with the structured data (time series database) and generating meaningful insights.

Further, the search engine of data ingestion module may be used to extract the various workover reports from the entire dataset, e.g., a particular type of report or data files 302 from within the repository 309. The search engine can be used on any dataset to extract any kind of files like workover reports, completion reports, frac reports, etc. For example, the workover reports are different file types, PDFs, excel, word, ppt, etc. and the information within them are also arranged in different formats. Thus, the data enrichment module 400 may include a fact extraction module that extracts entities from these files in a key value manner wherein from these workover files it extracts values of attributes like well name, date of workover, type of intervention, cost related to the workover etc. and organizes and aggregates this extracted information of each well over time and across wells in the field in a structured chronological order. The module 400 may then form associations between this structured information and the production time series data.

This organized data works as a master sheet for various informative analysis of the data. For example, the extracted information can be used to generate performance indicators 404 such as calculating operating spending and frequency of occurrence across each workover type by time, by primary job types and generating insights into dominant and prevalent workovers historically based on the spending and frequency of occurrence. Also, the module 400 may identify episodic intervention activities on production timeline of oil, gas and water by well, as indicated at 406. A variety of visualizations may be employed to depict such information, such as plots of well production over time, plots of expenditures on wells over time, or combinations thereof. Such visualization helps generate insights on the phases in the life and production behavior of each well when workover activities were performed and how frequently these operations were done.

As a specific example, workover reports may contain multiple free-form text data fields, such as short reports descriptions, and other entities that are written by operations or interventions engineers describing the workover job (cause, observations, actions taken and impact) and the entity containing the ‘workover title’ or ‘workover job type’ is either missing or empty. Because of the missing workover title, subject matter experts (SME's) read the descriptions and process the reports manually to infer their workover job type. Thus, the data enrichment module 400 may include a supervised learning tool 402, through which a neural network model may be trained to infer workover types from their ‘short reports’ or ‘descriptions’. It will be appreciated that the supervised learning tool 402 may be readily implemented to infer other document types based on similar short reports, descriptions, titles, etc.

The machine learning implemented as part of the data enrichment module 400 may learn different classes of activity types. Continuing with the example of workovers, this refers to different workover types. In an experimental example, three classes were identified: ‘Artificial Lift’, ‘Well Integrity’ and ‘Surface Facilities’. A labeled dataset of known workover descriptions and their workover types may be employed to train a multi-layer (e.g., three-layer) neural network multi-class classification model. In the experimental example, a data set of 270 training workover descriptions was employed to train the model, and the model performed with an accuracy of about 85% on new unseen data, categorizing the workovers into the aforementioned three classes. Larger training data sets may be employed to increase accuracy and/or increase the number of classes.

This model may help reduce the turn-around time to interpret, classify and analyze workover reports. It can also be used to predict labels on present or future reports with missing workover types across fields. These models can be improved with more data and our aim is to make them more robust by exposing them to different kinds of workover descriptions and types and thus improving their capabilities in the future.

As a result of data enrichment, the module 400 performed association of episodic intervention activity with well performance, NLP-enabled learning from associated free text expressed as graphs, and calculation and visualization of performance indicators to identify wells that were candidates for performance improvement.

The next phase, referring again to FIG. 2, is the knowledge generation phase 206. Data ingestion and enrichment glean structured data from unstructured documents across various wells which can be used to train machine learning models. These models and results can be abstracted and analyzed at both well and field level for performing field evaluation. The performance indicators and dashboards help generate actionable insights for field operations which can be used by asset managers and operations engineers with field planning and operations to increase production, choose an appropriate intervention mechanism and replicate beneficial practices determined from historical learnings. In this manner, the knowledge generation phase 206 helps in automating the field optimization process in a data-driven, artificial-intelligence manner.

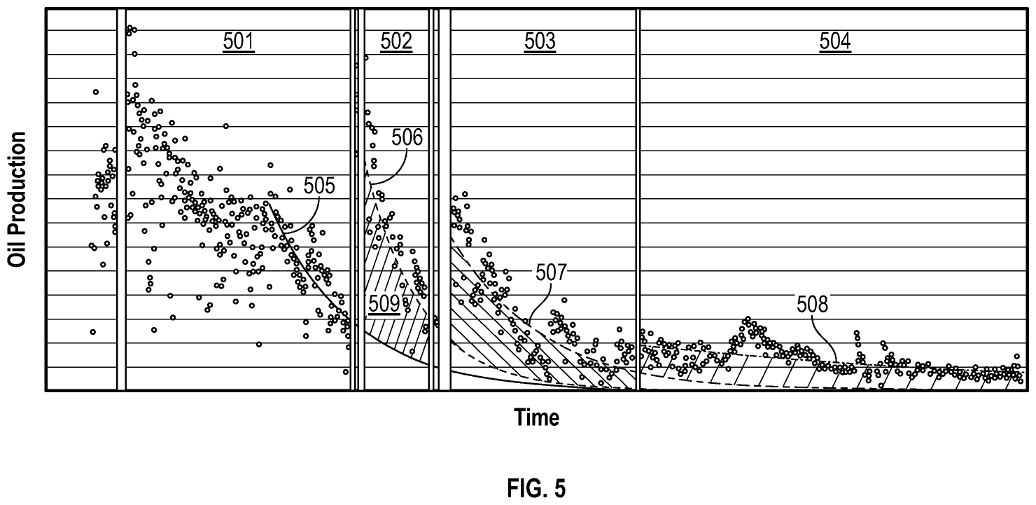

Once the episodic interventions activities are connected to time series data, calculations may be performed to forecast and compare individual well production with and without workover intervention. This model assists in determining and quantifying production and economic upside due to each intervention. In this manner, economic metrics (e.g., return on investment) may be estimated for each workover as can be seen from the plot of FIG. 5, as will be described in greater detail below.

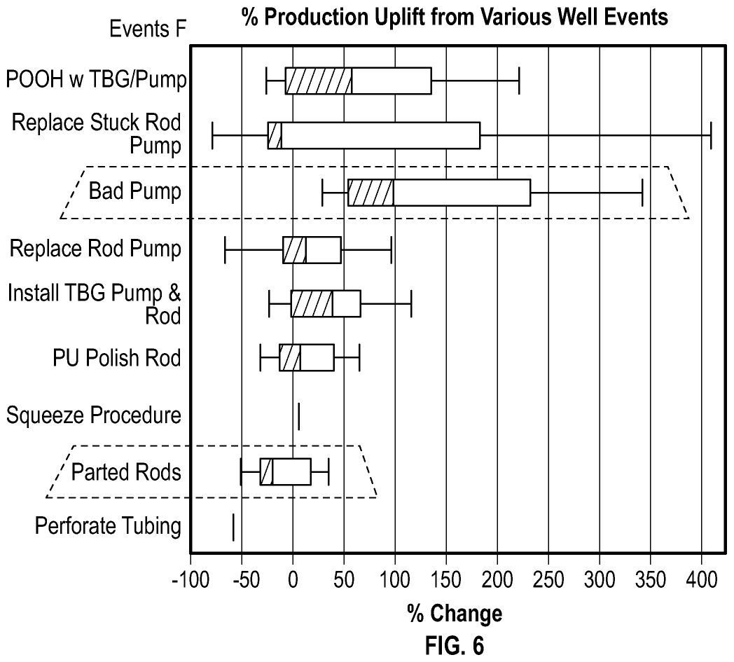

Workovers across zones, areas, and fields may be identified by this computer-implemented workflow. Further, production upside for individual workovers across each well in the field may be estimated and analyzed at field level using box plots as shown in FIG. 6, as will be described in greater detail below. This dashboard can facilitate gaining an understanding of the range of impact for the different workover classes on production and can be used by users, such as subject matter experts or (“SMEs”) to rank historical workovers, understand bottlenecks, learn best practices from the past operations so that they can refine their present and planned interventions operation strategy (e.g., in a field optimization phase as shown in FIG. 2).

FIG. 5 illustrates a plot of oil production as a function of time, e.g., for a well or a group of wells that make up a pad or field, according to an embodiment. In particular, FIG. 5 represents an example of a historical data analysis (or “analytic”) for an oilfield and/or one or more wells individually. In this case, oil production is indicated as a function of time, with regressions presented to indicate a return (in terms of production) for various workover operations. It will be appreciated that a variety of other historical data analytics could be provided, e.g., evidencing the impact of drilling activities, artificial lift selection, hydraulic fracturing, etc., on contemporaneous or subsequent well production, longevity, present value, total production, economic viability, etc.

In the illustrated example, the plot is broken into zones, e.g., zones 501, 502, 503, 504. The vertical lines separating the zones 501-504 represent well events (e.g., workover operations, maintenance, equipment failure, etc.) that were experienced as noted in the data. Both the production data and the well-event data may be received as time-series data, e.g., from different sources across a wide variety of file types. This data may be sorted according to the method discussed above and employed to create the illustrated plot.

Regressions 505, 506, 507, 508 may be calculated for the data in the individual zones 501-504. The regressions 505-508 may represent “what if” scenarios, in particular, indicating an impact of the well events that were experienced (i.e., those separating one zone from another) were not conducted. For example, referring to regression 505 for zone 501, it is shown to decay, e.g., in a generally hyperbolic manner towards zero. However, the production is changed by the well-event represented by the vertical line between the zones 501, 502. In this case, the production is increased, and thus this well event may be representative, e.g., of fixing a piece of equipment. As such, a new regression 506 is determined.

The difference between the regressions, illustrated by area 509, indicates the impact in terms of production of the well-event. In cases where the well event represents a paid-for activity, e.g., maintenance or a workover, the area 509 may represent a return on the investment, both in time and cost. This can be conducted for each of the zones 501-505. Moreover, a trend to the returns from the well events (e.g., diminishing) may facilitate making a forecast on a return of a subsequent paid-for well events (e.g., workovers). This may facilitate determining whether to conduct a workover, and what type to perform, e.g., depending on the expected return. Further, by comparing data across a wide variety of wells, well events, such as equipment failure, may be expected and the costs associated therewith accounted for.

As noted above, the type of well event may result in a different change in production. This change may be calculated based on historical data, if the historical data is parsed and available, as described above. FIG. 6 illustrates an example of several such well events. For example, correcting a bad pump can provide a range of returns, from e.g., about 50% to about 200% increase, while ported rods can have a net positive or a net negative effect, as highlighted. The historical data, parsed as discussed above, can facilitate an understanding of the well events that are happening, or those that can be implemented.

The yearly activity and costs, or in some other window of time, of workover type may also be extracted from the data files. For example, the type of workover activity conducted in a particular field may be extracted from workover reports, and associated with an increment of time (e.g. year). Likewise, the costs spent on workovers in that field may also be extracted. This data may be correlated to production data, such that a return realized by the workover, e.g., as a function of cost, may be established.

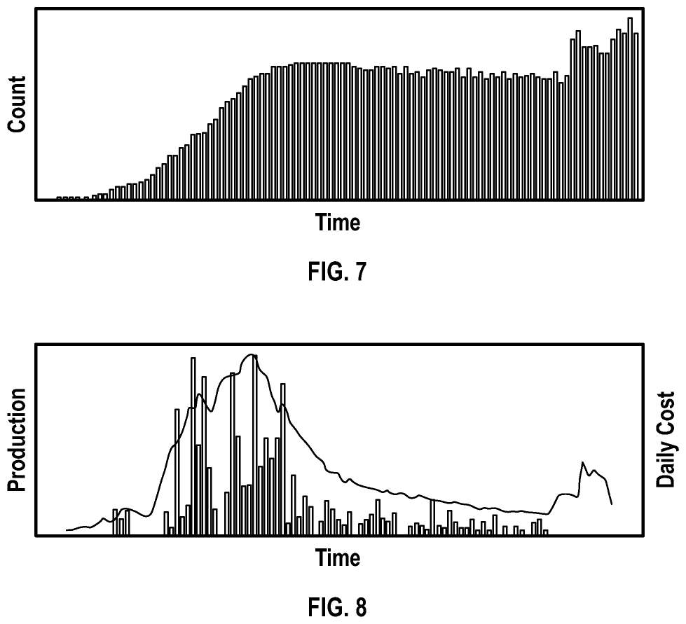

Using the data that is extracted from the repository, classified, and analyzed, various visualizations representing oilfield productivity may be generated. For example, as shown in FIG. 7, the number of wells that are active in a field may be tracked. Production (line graph) and daily cost (bar graph) may likewise be tracked, as shown in FIG. 8, such that it becomes apparent the likely impact of drilling more wells, the cost per unit of oil, etc. This may indicate the return on investment for additional drilling, shutting in wells, working over wells, etc., as well as the maturity of the field, expected value of the production therefrom, etc.

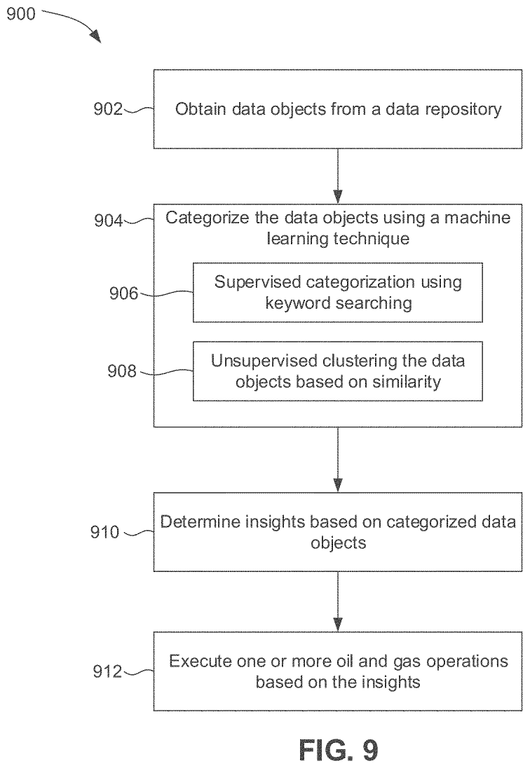

FIG. 9 illustrates a flowchart of a method 900 for processing large amounts of oilfield data of various different types for oilfield management and evaluation, among other things, according to an embodiment. The method 900 can be implemented with any suitable computing device. Further, the method 900 may be a specific embodiment of the method 200 discussed above, and thus should not be considered mutually exclusive therewith.

The method 900 may begin by obtaining one or more data objects from a data repository, as at 902. In some examples, the data objects can be identified from a data repository of structured data and unstructured data. The structured data can include time series and relational databases, among others, and the unstructured data can include documents and files such as electronic documents and scanned copies of hand-typed documents. In some examples, the unstructured data can be cataloged, metadata can be extracted, and optical character recognition techniques can be applied to unstructured documents that include handwritten notes.

Embodiments of the present disclosure may include tools for receiving and pre-processing (“ingesting”) data that can translate unstructured data into an appropriate format for ingestion, correlation, and modeling. Automated tools may include cataloging files across complex folder structures, metadata extraction, optical character recognition to extract hand-written and scanned information, keyword search engines to extract files of interest to subject-matter experts. Once the files are collected, embodiments may apply advanced fact extraction capabilities can translate unstructured data sources like workover reports, approval for expenditure (AFE) sheets, etc. into structured tables of attributes listing important well and workover intervention properties. The extracted data streams are correlated with production time series data to analyze intervention activities and model production upside across various class of workovers. Further, neural network architecture may learn and infer workover classes from free text.

The method 900 may also include categorizing the data objects using a machine learning model, as at 904. The machine learning model may be supervised, as indicated at 906. That is, a user may conduct keyword searches and tag at least a portion of the data objects with a particular classification. The classifications may be implemented based on what type of file results from the keyword searching, e.g., workover reports, drilling reports, and production reports may be characterized by including some similar but many different words. Thus, the human user's classification of a first subset of the documents into different categories based on the words contained therein may form a training corpus. A machine-learning model may be trained using this corpus, such that the artificial intelligence embodied by the machine-learning model is capable of predicting what an expert would label the various documents, again, based on the words contained therein. Accordingly, the machine-learning model may label a second subset of the documents/data objects.

This may be implemented using a neural network. For example, the neural network can include two or more fully interconnected layers of neurons, in which each layer of neurons identifies a broader characteristic of the data. In some embodiments, the neural network can be a deep neural network in which weight values are adjusted during training based on any suitable cost function and the tags generated based on the simulated values. In some examples, additional techniques can be combined to train the supervised neural network. For example, the supervised neural network can be trained using reinforcement learning, or any other suitable techniques. In some embodiments, the supervised neural network can be implemented with support vector machines, regression techniques, naïve Bayes techniques, decision trees, similarity learning techniques, and the like.

In another embodiment, categorizing at 904 may rely or otherwise implement an unsupervised clustering of the data objects based on similarity, as at 908. Such an unsupervised clustering is discussed in greater detail below. In general, however, the clustering technique may associate a score or vector with the data object, which produces a “location” thereof within a multi-dimensional space (with the number of dimensions of the space based on a number of features that are represented in the vector). Clusters are then determined based on the proximity of the locations of the data objects in the space, i.e., based on their vectors.

Once the clusters (or at least some clusters) are identified, the data types of the objects contained within the clusters may be labeled by a user, e.g., based on a word cloud or another visual representation of the data files contained within the cluster. The clusters may thus represent data objects of the same general type, e.g., one cluster may be for workover reports, while another is for drilling logs, and another is artificial lift data. In some embodiments, the clusters may represent different actions (e.g., workovers, interventions, fracturing operations, drilling operations, production operations, completion operations, etc.). The label can be automatically determined via the machine learning technique, or may be determined and applied via input from a human user, e.g., based on the word cloud, which may facilitate a quick understanding of the contents of the cluster by the human user. The clustering may then continue to place data files within the clusters, based on the similarity of the contents of the files and/or the metadata thereof with the other files in the various clusters.

At block 910, the method 900 can include generating insights at least partially based on the categorized data. For example, correlations between money spent on workover operations and return (in terms of daily oil production) may be determined and/or forecasted in the future, under various “what if” scenarios, e.g., to determine an optimal course of action for field planning. Accordingly, one or more oil and gas operations may be executed based on the insights, as at 912, so as to enhance field production in the long or short term, minimize costs, etc. In some embodiments, the oil and gas data operation includes field planning and operations to recover additional resources from a reservoir, identifying an intervention technique for an oil and gas operation, or identifying a historical workover technique to increase production from the oil and gas operation.

In some embodiments, once a well has been completed and has produced for some time, the well can be monitored, maintained and, in many cases, mechanically altered in response to changing conditions. Well workovers, or interventions, refers to the process of performing maintenance or remedial treatments on an oil or gas well. In many cases, workover implies the removal and replacement of the production tubing string after the well has been killed and a workover rig has been placed on location. Workovers include through-tubing workover operations, using coiled tubing, snubbing or slickline equipment, to complete treatments or well service activities that avoid a full workover where the tubing is removed. Workover and intervention processes include various technologies that range in complexity from running basic slickline-conveyed rate or pressure control equipment to replacing completion equipment.

In some examples, the oil and gas data operation includes a modification to the oil and gas extraction unit that resulted in the change in flow of the resources. For example, a workover can be identified for a particular oil rig that resulted in an increased amount or flow of resources from a reservoir.

### Unstructured Classification of Different Types of Data Files

As mentioned above with respect to block 908 of FIG. 9, embodiments of the method 900 may implement an unsupervised clustering algorithm. It will be appreciated, however, that this algorithm may be executed outside of the context of the method 900, as will be discussed herein. Accordingly, embodiments of the disclosure may also provide an ensemble machine learning (ML) workflow that combines natural language processing (NLP) and unsupervised clustering to automatically organize and classify large volumes of unstructured data, e.g., regardless of format and complexity (scanned, electronic, images, logs, etc.), thus expediting extraction of insights from historical data for field optimization.

The workflow may be implemented as an unsupervised workflow combining NLP and ML. For example, NLP may be used to parse scanned and electronic records, clean and tokenize text, and build high-dimensional vector space from numerical weights determined for contiguous sequence of words. It then uses ML to group similar documents using clustering algorithm configured to minimize spatial overlap among model features. Documents may be classified based on text corpus representing each cluster. The framework can process large amounts (e.g., gigabytes to petabytes) of unstructured data, diverse formats (pdf, word, excel, images, etc.) and varied array of documents (geology, logs, drilling, completions, workovers, fracking, etc.).

The workflow may handle documents containing information about drilling, workovers, completions, fracturing, commissioning, geology, etc. Manually reading and organizing thousands of files into their respective categories is a time-consuming and labor-intensive task, making it almost impossible for engineers to do it effectively. The framework includes a big-data pipeline, NLP and ML engines within a scalable infrastructure on cloud. Even with an unbalanced dataset, the engine can build highly accurate clusters of similar documents.

The multi-dimensional space in which the data files are located can be represented in a 2D projection of a multi-dimensional hyperplane, with dots representing the documents, as will be described in greater detail below. The present workflow may be capable of defining clear separation boundaries for the clusters, e.g., with 90%, 95%, 97%, or more precision and recall. Word clouds depicting keywords representative of each cluster may also be created and visualized, each being unique in its corpus and significant of a specialized domain. The document(s) present at the cluster centroid together with the word cloud for each cluster can be used by domain engineers to quickly classify the whole cluster set. In this manner, many (e.g., thousands) of documents may be categorized within few minutes, supplanting the manual process that took weeks.

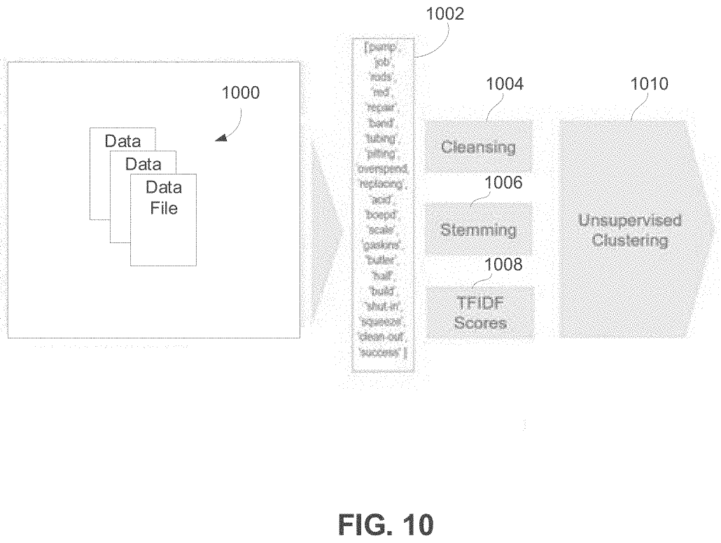

As diagrammatically shown in FIG. 10, embodiments of the present disclosure may, e.g., in the context of an oilfield data analysis platform (e.g., as discussed herein with reference to FIGS. 1-9) organize disparate data files and types into categories or classes of data, from which information may be gleaned.

Available tools for sentiment analysis, predictive analysis, and document/topic classification in text, e.g., in open-source libraries, are supervised and require labelled dataset to learn from or otherwise are unsuited for the complexity of the oil and gas data. The documents in the data set may be of multiple file types likes PDF, word, excel, ppt, csv, txt etc., the data within each document is organized differently and no uniform format has been followed in the documents. The documents contained cross section diagrams, periodic charts and time series data where essential information was mentioned alongside these figures. Further, one or more different filetypes may be characteristic of different types of data, e.g., workover, frac summaries, regulatory filings, and/or completion logs or other associated types of documents. However, the filetypes may cross-over, e.g., workover reports and frac summaries may include the same types of files, which may or may not have uniform conventions for naming the files, etc.

Accordingly, embodiments of the present disclosure may implement a clustering process to organize and classify the data. Rather than initiating a learning process by having a a subject-matter expert (SME), i.e., a human, label files, once a representative sample of a cluster is provided to SME, the method can include labeling the cluster based on a few labels tagged by the SME. This assistive approach reduces time spent labelling by a human and speeds up the process of creating supervised algorithms to generate trained models.

The present workflow may be configured to disassociate large quantities of data which are unstructured using an unsupervised machine learning clustering algorithm by leveraging customized data cataloging and structuring, redesigned feature extraction techniques, and a tailored, enhanced clustering to reduce the distance (e.g., error) between similar documents, thus grouping them together to form a cluster. These clusters (e.g., groups of documents) can be labelled by studying a sample. The various categories may include workover files, frac summary reports, rod and tubing details, completion reports, among others.

In some embodiments, as shown in FIG. 10, the workflow may include cleaning and tokenizing textual data from unstructured documents to generate features to be used as building blocks of the classification/clustering of the documents. For example, the data files 1000 may be scanned using a data ingestion module that is capable of handling multiple formats and agnostic to folder structure. Words 1002 may be extracted from the data files, which may become features. Context for the words 1002 can be introduced using n-grams. The words 1002 may then be cleansed, as at 1004, e.g., erroneous words, such as those incorrectly recognized in an OCR, may be removed and/or corrected. Further, stemming may be applied, as at 1006, e.g., to remove suffixes, conjugations, etc., so as to be able to compare the root words. Finally, a term frequency (TF) and inverse document frequency (IDF), or TFIDF, score may be generated for the documents. Using the scoring, and the words 1002 after cleansing and stemming, the unsupervised clustering may be initiated, as indicated at 1008. Clusters may be determined in any of the manner discussed herein, so as to identify documents related to common subjects, types of data, etc.

The embodiments of the present disclosure may include a data extraction module that breaks down the unstructured format of the data. The algorithm parses directories and subdirectories up until the root level and extracts files of a certain format or belonging to a particular folder if specified by the user. The files extracted may include a variety of formats, such as excel, pdf, word, ppt, txt, csv. The algorithm may allow for extraction of these file formats from the entire data dump or from specific folders (as seen by the user in the data set) from which files of identified formats should be extracted. This makes the method user friendly and customized to an individual client's work, as individual clients can choose the kind of files the want to extract information from and the folders they want to extract these files from.

Once the module has access to the files, it reads and extracts the text blob from these documents and stores the metadata like file name, file type, title of the file, hyperlink to the file, path of the file etc. along with the text/Bag of Words in an excel sheet. This generates a tabular, well arranged database where each row represents the vital information pertaining to each document. For example, Python libraries such as xlrd, textract, pypdf2 etc. may be used to read and extract data from the different file formats.

The module may create a structured database from the unstructured documents to provide an organized input to the learning algorithm. It also keeps track of metadata from the documents which can be used as features to distinguish documents and aid in the clustering task.

This module may reduce time spent opening individual folders/files and manually reading the documents therein. This automated data mining reduces the tedious effort by providing the information contained in a dataset, e.g., in a single excel sheet.

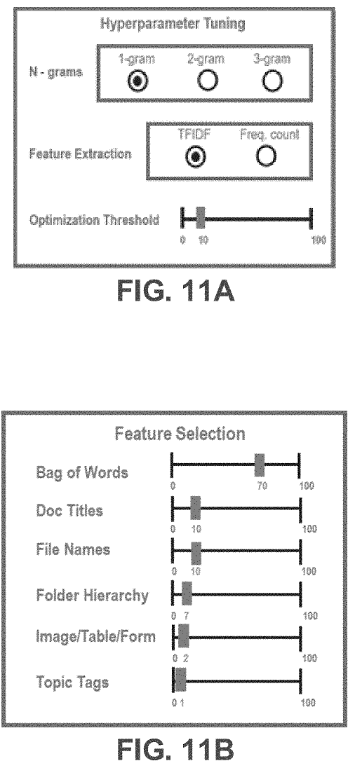

FIGS. 11A and 11B illustrate two dashboards. A feature extraction module uses the organized data from the data extraction module to create the basis for machine learning therefrom. A feature is word or phrase from a blob of text which describes or represents what that text symbolizes.

The clustering module may execute the machine learning algorithm. It may be a type of unsupervised learning algorithm including input data without labeled responses. It is used to find meaningful structure, explanatory underlying processes, generative features, and groupings inherent in a dataset. Clustering is a task of dividing the corpus or data points into various groups such that data points in the same groups are more similar to other data points in the same group and dissimilar to the data points in other groups. Generally, it is a collection of objects based of similarity and dissimilarity between them.

The algorithm follows (e.g., two) iterative steps, assigning data points as centroids and finding distances of other data points to the centroids, here each data point represents a document in the data set. It begins by assigning random data points as centroids and measuring the distances of the others to these centroids. This process continues iteratively until no new clusters can be created, which means the dataset is segregated in groups which cannot be further broken or distinguished. The scheme is that the error of the distance is reduced, i.e., the iterative clustering continues, until the number of data points which have distances greater than 1 from their respective centroids is minimum. This small quantity of data points are considered as outliers and are identified in a “miscellaneous” category.

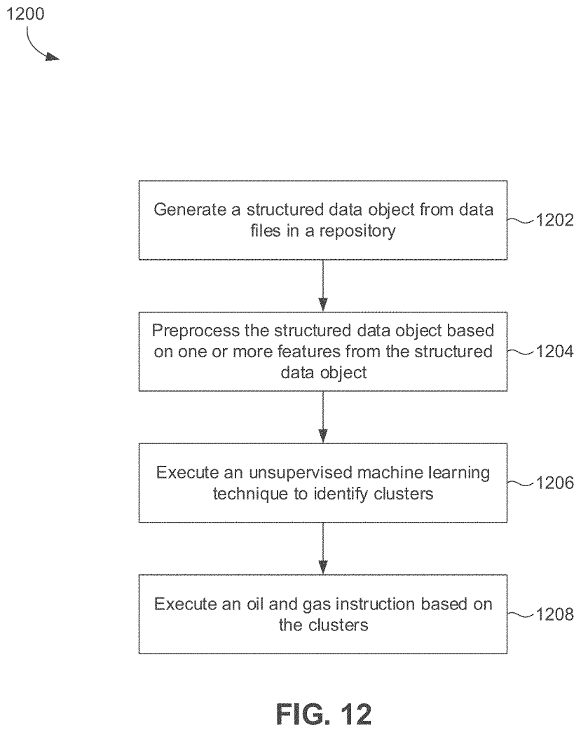

FIG. 12 illustrates a flowchart of a method 1200 for clustering data, according to an embodiment. At block 1202, the method 1200 can include generating a structured data object from a plurality of data files in a data repository. In some examples, the data files include one or more structured data files, one or more unstructured data files, or a combination thereof. In some embodiments, the structured data object comprises metadata for each of the data files, wherein the metadata comprises at least one of a file name, a file type, a file title, a hyperlink to the file, or a path of the file. In some examples, the structured data object is a database table and the metadata is stored in the database table.

In some embodiments, a user request can specify a subset of data from the repository to be included in the structured data object. For example, the user request can indicate a subset of files of a directory to be included in the structured data object, among others.

At block 1204, the method 1200 can include preprocessing the structured data object based on one or more features from the structured data object. Data preprocessing may be employed as a first workstep (or precursor) to feature extraction. The preprocessing may include cleaning the data of stop words, e.g., by creating a dictionary of stop words prevalent not only in the English language but also in the O&G industry documents. The numbers, alpha numeric characters, punctuations and special characters may be removed from the text blob. This prevents the machine from learning redundant information which will not add any value to the task of distinguishing documents.

The preprocessing may also include tokenizing the data prior to Term Frequency-Inverse Document Frequency (TFIDF) vectorization to extract features. Tokenization is the process of breaking up the given text into units called tokens, where each word in the text becomes a single entity/element.

TFIDF or Term Frequency-Inverse Document Frequency is methodology which defines how important a term is in a document with respect to all the documents in the dataset. It is used as a term weighting factor where the TFIDF score represents the importance of a word/phrase/feature in a textual paragraph within a corpus by counting its frequency in a document and the frequency of the documents it appears in within the entire data set. This cuts down on frequently appearing words across the corpus since these words add no value to the clustering task. Also, the design has a provision to run the frequency count methodology if the user specifies. Here the term weighting scores are based only on the frequency of the terms within each document.

These methods generate a matrix containing the term weighting scores of each word in each document. Each row of the matrix is a document and each column represents a word/phrase/feature and the elements in this matrix are the weighting scores. The features are a collection of unique phrases or words across the entire corpus.

Though the dictionary contains unique words, it can be further cleaned by stemming some words. The issue with off the shelf stemming libraries is that they can be quite unpredictable while lemmatizing words and have low accuracy. Embodiments of the present disclosure may stem the words such that words with “ing”, “ment”, “ed” and singular-plurals can be boxed as the same word. More such features can be added based on user requirements easily as the framework is already organized. Once a new dictionary is ready the matrix of scores are modified. To enable this, the columns/features that have the same root word across the documents are tracked, then these columns are deleted and the score for each document added to create a single column of the added scores across the document. The score may be appended to the matrix with the column name as the root word of that group. This reduces the time taken for stemming since it runs on a small group of unique words representing the corpus rather than the raw text from the documents.

In some examples, the terms of each document can be counted, Boolean frequencies can be generated representing each word of each document, term frequency adjusted for the document length can be calculated, a log-arithmetically scaled frequency can be calculated, or an augmented frequency can be calculated to prevent bias towards longer documents by determining a raw frequency value for each word of each document divided by the raw frequency of the most occurring word or term in each document. In some embodiments, a search engine can score and rank the relevance of each document based on the matrix.

Thus, the module may generate features from each document so that they can form as an input to the machine learning algorithm and it can learn from it. In some embodiments, any suitable model, such as a word2vec model, can detect any number of files, structured data, or unstructured data from a data repository and produce a vector space with any number of dimensions. The vector space can include a vector for each word in the received data. Words that share common contexts can be situated close to one another in space. In some embodiments, the word2vec model can be configured to have a sub-sampling rate, a dimensionality value, and a context window, among others. The sub-sampling rate can represent words that are identified with a predefined frequency above a threshold. For example, the word “the” may occur with a high frequency within text of a data repository, so that the word “the” can be sub-sampled to increase the training speed of a word2vec model. In some embodiments, the dimensionality can indicate a number of vectors representing the words of the text of the data repository. In some examples, the context window can indicate a number of words before or after a given word that can be considered for context of the given word. In some embodiments, the context window can be a continuous bag of words (CBOW) or a continuous skip gram. With the CBOW context window, the word2vec model can predict a word from a window of surrounding words. The continuous skip gram context window can use a word to predict a surrounding window of context word such that nearby context words are weighted more heavily than distant context words. In some examples, the continuous skip gram model can result in more accurate results than the CBOW context window. The number of instructions to process the continuous skip gram model can be larger than the number of instructions to process the CBOW context window.

At block 1206, the method 1200 can include executing an unsupervised machine learning technique to identify one or more clusters of data files from the plurality of data files in the data repository, e.g., after preprocessing. In some embodiments, the unsupervised machine learning technique can include generating a matrix from the one or more features. The matrix may include one or more frequency values representing a frequency of at least two words in each of the plurality of files. Additionally, the unsupervised machine learning technique can include determining a distance between the at least two words. In some examples, identifying the one or more clusters using that distance between the at least two words can also be performed by the unsupervised machine learning technique.

In some embodiments, the unsupervised machine learning technique can include identifying a boundary for each of the one or more clusters, wherein the boundary represents a distance from a centroid value that separates a first cluster from a second cluster.

At block 1208, the method 1200 can include executing an oil and gas data instruction based on the one or more clusters. In some embodiments, the oil and gas data instruction can include aggregating data files from the plurality of data files that share one of the one or more clusters. In some examples, the oil and gas data instructions include generating a second structured data object including data from the aggregated data.

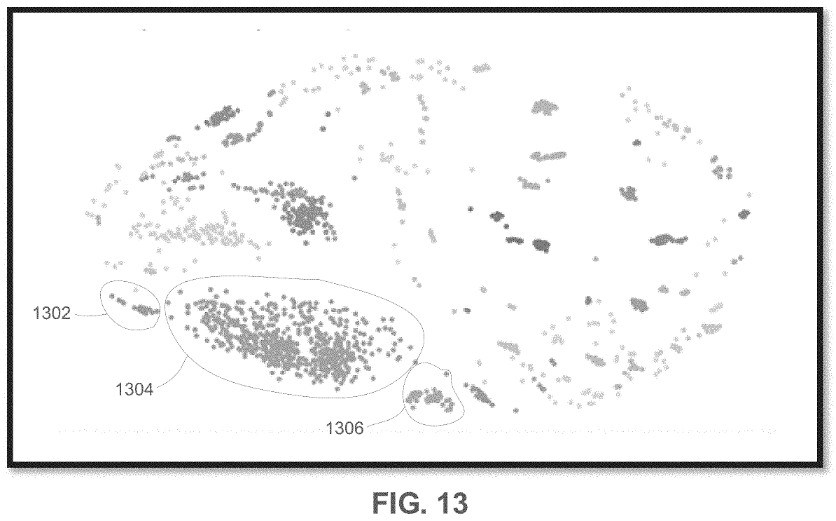

FIG. 13 illustrates the clustered output of the module, according to an embodiment. Each dot may represent an individual document. Documents which are close together spatially are similar in content, and may be grouped into a same cluster (three of several clusters are indicated, for ease of illustration, and indicated as 1302, 1304, 1306). The depicted visualization, which may be presented to a user in this graphical form or another, is a planar view of the high dimensional feature space on a 2D plane with respect to the distance between data points.

To better understand the groupings of the files within each cluster, word clouds that chart the most representative words of the files of the cluster may be created. FIG. 14 illustrates an example of such a word cloud, where the size of each word represents its significance in determining the cluster. Further, documents may be created and stored in folders according to their cluster number for analysis of confidence in the algorithm.

Referring again to FIG. 13, the cluster 1304 appears to have the greatest number of data points for a single cluster, in this example. The documents in the cluster, in this case, may not provide insight into the type of data represented, and there may be many such files. The word cloud associated therewith, however, may represent the dominant features of the cluster as well as a sample report from the cluster. In the word cloud of FIG. 14, for example, which may be illustrative, features like rod, safety, incident, accident, afe, tbg, rig, cost, pump etc. stand out and are pointing towards the cluster relating to some intervention activity being performed on the well. Furthermore, the sample report says morning workover report in its title and the contents are describing the intervention activity and its cost for that day.

When an SME is given the above information, the 2D plot of the documents clustered spatially, the word cloud of representative features and a sample document from the cluster, the SME may label the cluster as related to workover or intervention activity. Based on this label by the user, the cluster 1304 may be labeled as workover reports, and subsequently-processed documents that fit in this cluster 1304 may likewise be labeled as workover reports, without being physically labeled by the SME.

Using the above information, the 2D plot of the documents clustered spatially, the word cloud of most representative features and a sample document from the cluster, the SME has enough confidence to tag the sample and invariably create a database by unconsciously tagging the entire cluster of documents.

Further, the clusters 1302, 1304, 1306 may be considered for merging, based on their close proximity to one another, e.g., based on the similarity distance falling below a predetermined or dynamic threshold. Indeed, spatially these clusters 1302-1306 could have been the same cluster, but have been disjoined to form separate clusters. Going into further details and extracting sample files from both these clusters are similar, but the word clouds may evidence little overlap. For example, documents in one of the clusters may contain workover and cost information and documents in another of the three clusters may contain rod and tubing information. Documents in contain some varied information. This cluster contains workover, cost and rod & tubing information, as can be seen above. Thus, it is situated so close to the other clusters in the spatial 2D plane as its feature space is the union of the features from the two other clusters. This is also the reason why one cluster is dissimilar from another, even though the file names are similar, the cluster contains information beyond workovers i.e. rod and tubing details. The unsupervised algorithm recognizes this fundamental difference and groups it in a different category.

Referring back to FIG. 12, once the clusters are labelled, and this may be an ongoing effort with new clusters being identified periodically, the method 1200 may continue the unsupervised machine learning process at 1206 so as to continue clustering and categorizing a the data files selected, e.g., without SME intervention. The unsupervised algorithm may thus reduce human effort. The algorithm may not rely on having a balanced dataset, but clusters the unbalanced data in an unbiased manner. The algorithm is generic in nature and is not restricted by any specific type of documents.

### Computer Processor for Executing the Methods

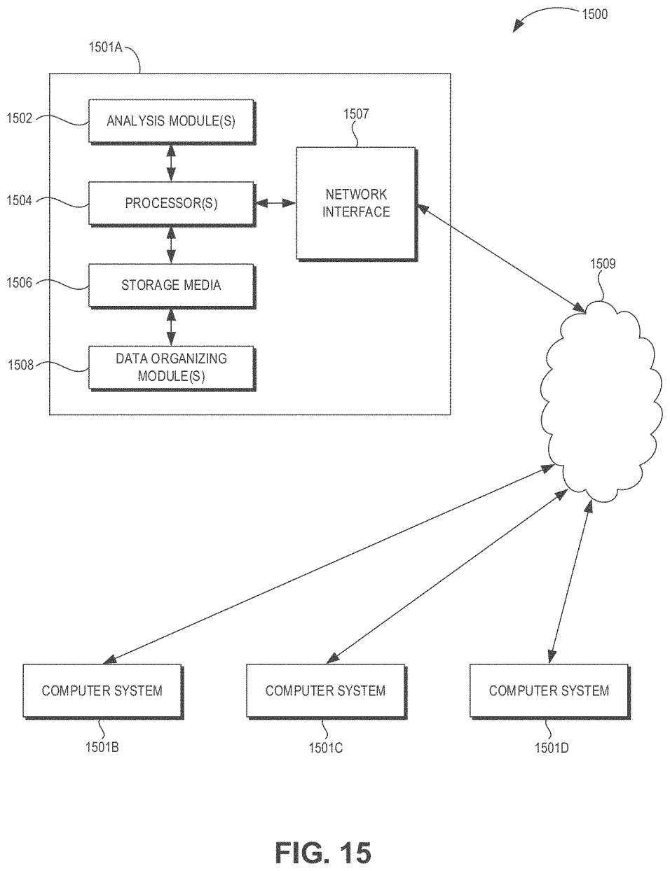

In some embodiments, the methods of the present disclosure may be executed by a computing system. FIG. 15 illustrates an example of such a computing system 1500, in accordance with some embodiments. The computing system 1500 may include a computer or computer system 1501A, which may be an individual computer system 1501A or an arrangement of distributed computer systems. The computer system 1501A includes one or more analysis modules 1502 that are configured to perform various tasks according to some embodiments, such as one or more methods disclosed herein. To perform these various tasks, the analysis module 602 executes independently, or in coordination with, one or more processors 1504, which is (or are) connected to one or more storage media 1506. The processor(s) 1504 is (or are) also connected to a network interface 1507 to allow the computer system 1501A to communicate over a data network 1509 with one or more additional computer systems and/or computing systems, such as 1501B, 1501C, and/or 1501D (note that computer systems 1501B, 1501C and/or 1501D may or may not share the same architecture as computer system 1501A, and may be located in different physical locations, e.g., computer systems 1501A and 1501B may be located in a processing facility, while in communication with one or more computer systems such as 1501C and/or 1501D that are located in one or more data centers, and/or located in varying countries on different continents).

A processor may include a microprocessor, microcontroller, processor module or subsystem, programmable integrated circuit, programmable gate array, or another control or computing device.

The storage media 1506 may be implemented as one or more computer-readable or machine-readable storage media. Note that while in the example embodiment of FIG. 15 storage media 1506 is depicted as within computer system 1501A, in some embodiments, storage media 1506 may be distributed within and/or across multiple internal and/or external enclosures of computing system 1501A and/or additional computing systems. Storage media 1506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1500 contains one or more data organization module(s) 1508. In the example of computing system 1500, computer system 1501A includes the data organization module 1508. In some embodiments, a single data organization module may be used to perform some aspects of one or more embodiments of the methods disclosed herein. In other embodiments, a plurality of data organization modules may be used to perform some aspects of methods herein.

It should be appreciated that computing system 1500 is merely one example of a computing system, and that computing system 1500 may have more or fewer components than shown, may combine additional components not depicted in the example embodiment of FIG. 15, and/or computing system 1500 may have a different configuration or arrangement of the components depicted in FIG. 15. The various components shown in FIG. 15 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1500, FIG. 15), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. A method for analyzing data comprising:
obtaining data objects from a data repository, wherein the data objects comprise observational data related to one or more oil wells, oil fields, or a combination thereof;
classifying the data objects based on data contained therein using a machine-learning algorithm;
determining output data from the data objects after classifying the data objects, wherein the output data represents one or more historical data analytics for the one or more oil wells, oil fields, or a combination thereof; and
visualizing the output data including the one or more historical data analytics.

2. The method of claim 1, wherein classifying the data objects comprises:
searching the data objects using keywords;
labeling a first subset of the data objects based on searching the data objects using the keywords; and
labeling a second subset of the data objects using the machine-learning algorithm, wherein the machine learning algorithm is trained based on labels applied to the first subset of the data objects.

3. The method of claim 1, wherein classifying the data objects comprises:
clustering, using the machine-learning algorithm, the data objects into clusters based on a similarity value calculated based on words contained in each of the data objects, wherein the machine learning model is unsupervised; and
receiving labels of the clusters, wherein the labels represent a type of data objects contained in the individual clusters.

4. The method of claim 1, further comprising executing an oil and gas data operation based at least in part on the visualized output data.

5. The method of claim 4, wherein the one or more historical data analytics represent a change in hydrocarbon production from the one or more wells, one or more oilfields, or the combination thereof in response to one or more oilfield operations.

6. The method of claim 1, further comprising conducting field planning and operations to recover additional resources from a reservoir, identify an intervention technique for an oil and gas operation, or identify a historical workover technique to increase production from the oil and gas operation, based at least in part on the one or more historical data analytics.

7. The method of claim 1, further comprising determining a return on an operation configured to enhance production from the one or more oil wells, the one or more oil fields, or the combination thereof based on the one or more historical data analytics.

8. The method of claim 1, wherein the one or more historical data analytics comprises an amount of hydrocarbon produced from a well or a field, an impact of one or more workover operations or interventions conducted on the well or the field, and an extrapolation of the amount of hydrocarbon that would have been produced in the operations or interventions were not conducted.

9. The method of claim 1, wherein the data objects comprise structured data and unstructured data.

10. The method of claim 1, wherein labeling the first subset and labeling the second subset comprise accessing metadata related to the first and second subsets, respectively.

11. A computing system, comprising:
one or more processors; and
a memory system including one or more non-transitory, computer-readable media storing instructions that, when executed by at least one of the one or more processors cause the computing system to perform operations, the operations comprising:
obtaining data objects from a data repository, wherein the data objects comprise observational data related to one or more oil wells, oil fields, or a combination thereof;
classifying the data objects based on data contained therein using a machine-learning algorithm;
determining output data from the data objects after classifying the data objects, wherein the output data represents one or more historical data analytics for the one or more oil wells, oil fields, or a combination thereof; and
visualizing the output data including the one or more historical data analytics.

12. The system of claim 11, wherein classifying the data objects comprises:
searching the data objects using keywords;
labeling a first subset of the data objects based on searching the data objects using the keywords; and
labeling a second subset of the data objects using the machine-learning algorithm, wherein the machine learning algorithm is trained based on labels applied to the first subset of the data objects.

13. The system of claim 11, wherein classifying the data objects comprises:
clustering, using the machine-learning algorithm, the data objects into clusters based on a similarity value calculated based on words contained in each of the data objects, wherein the machine learning model is unsupervised; and
receiving labels of the clusters, wherein the labels represent a type of data objects contained in the individual clusters.

14. The system of claim 11, wherein the one or more historical data analytics represent a change in hydrocarbon production from the one or more wells, the one or more oilfields, or the combination thereof in response to performing one or more oilfield operations.

15. The system of claim 11, wherein the operations further comprise conducting field planning and operations to recover additional resources from a reservoir, identify an intervention technique for an oil and gas operation, or identify a historical workover technique to increase production from the oil and gas operation, based at least in part on the one or more historical data analytics.

16. The system of claim 11, wherein the operations further comprise determining a return on an operation configured to enhance production from the one or more oil wells, the one or more oil fields, or the combination thereof based on the one or more historical data analytics.

17. The system of claim 11, wherein the one or more historical data analytics comprises an amount of hydrocarbon produced from a well or a field, an impact of one or more workover operations or interventions conducted on the well or the field, and an extrapolation of the amount of hydrocarbon that would have been produced in the operations or interventions were not conducted.

18. A non-transitory, computer-readable medium storing instructions that, when executed by at least one processor of a computing system, cause the computing system to perform operations, the operations comprising:
obtaining data objects from a data repository, wherein the data objects comprise observational data related to one or more oil wells, oil fields, or a combination thereof;
classifying the data objects based on data contained therein using a machine-learning algorithm;
determining output data from the data objects after classifying the data objects, wherein the output data represents one or more historical data analytics for the one or more oil wells, oil fields, or a combination thereof; and
visualizing the output data including the one or more historical data analytics.

19. The medium of claim 18, wherein classifying the data objects comprises:
searching the data objects using keywords;
labeling a first subset of the data objects based on searching the data objects using the keywords; and
labeling a second subset of the data objects using the machine-learning algorithm, wherein the machine learning algorithm is trained based on labels applied to the first subset of the data objects.

20. The medium of claim 18, wherein classifying the data objects comprises:
clustering, using the machine-learning algorithm, the data objects into clusters based on a similarity value calculated based on words contained in each of the data objects, wherein the machine learning model is unsupervised; and
receiving labels of the clusters, wherein the labels represent a type of data objects contained in the individual clusters.
